(19) United States
(12) Patent Application Publication
(10) Pub. No.: US 2015/0194226 A1
(43) Pub. Date: Jul. 9, 2015

(54) REACTOR CONTAINMENT PRESSURE SUPPRESSION

(71) Applicant: Babcock & Wilcox mPower, Inc., Charlotte, NC (US)

(72) Inventors: Robert P Martin, Lynchburg, VA (US); Michael J Edwards, Forest, VA (US)

(21) Appl. No.: 14/170,727

(22) Filed: Feb. 3, 2014

Related U.S. Application Data
(60) Provisional application No. 61/924,076, filed on Jan. 6, 2014.

(51) Int. Cl. G21C 11/00

(52) U.S. Cl. CPC G21C 11/00

(57) ABSTRACT

A nuclear reactor is surrounded by a reactor radiological containment structure. A spent fuel pool is adjacent to and outside of the reactor radiological containment structure. The spent fuel pool may also be contained in its own radiological containment structure. A valved steam pipe runs from the reactor containment structure into the spent fuel pool. During a reactor containment overpressure event, a valve on the steam pipe is opened to allow steam from the reactor containment structure to discharge into (e.g. sparge into) the spent fuel pool. In an alternative embodiment suitable for use in a two-pack nuclear power plant, steam pipes connect the reactor radiological containment structures of the two nuclear reactors, and isolation valves on the steam pipes are opened in response to an overpressure condition in one reactor containment structure in order to discharge steam into the other reactor containment structure.

This application claims the benefit of U.S. Provisional Application No. 61/924,076 filed Jan. 6, 2014. U.S. Provisional Application No. 61/924,076, filed Jan. 6, 2014, is hereby incorporated by reference in its entirety into the specification of this application.

### BACKGROUND

The following relates to the nuclear reactor arts, electrical power generation arts, nuclear safety arts, and related arts.

Nuclear reactors employ a reactor core comprising a mass of fissile material, such as a material containing uranium oxide (UO₂) that is enriched in the fissile ²³⁵U isotope. Primary coolant water, such as light water (H₂O) or heavy water (D₂O) or some mixture thereof, flows through the reactor core to extract heat for use in heating secondary coolant water to generate steam or for some other useful purpose. For electrical power generation, the steam is used to drive a generator turbine. In thermal nuclear reactors, the primary coolant water also serves as a neutron moderator that thermalizes neutrons, which enhances reactivity of the fissile material. Various reactivity control mechanisms, such as mechanically operated control rods, chemical treatment of the primary coolant with a soluble neutron poison, or so forth are employed to regulate the reactivity and resultant heat generation. In a pressurized water reactor (PWR), the primary coolant water is maintained in a subcooled state in a sealed pressure vessel that also contains the reactor core, and the liquid primary coolant water flows through a steam generator located outside the pressure vessel or inside the pressure vessel (the latter being known as an integral PWR) to generate steam to drive a turbine. In a boiling water reactor (BWR), the primary coolant boils in the pressure vessel and is piped directly to the turbine. Some illustrative examples of integral PWR designs are set forth in Thome et al., “Integral Helical Coil Pressurized Water Nuclear Reactor”, U.S. Pub. No. 2010/0316181 A1 published Dec. 16, 2010 which is incorporated herein by reference in its entirety, and in Malloy et al., “Compact Nuclear Reactor”, U.S. Pub. No. 2012/0076254 A1 published Mar. 29, 2012 which is incorporated herein by reference in its entirety. These are merely illustrative examples.

In either a PWR or a BWR, both pressure and temperature of the primary coolant water are maintained at controlled elevated temperature and pressure by heat generated in the radioactive nuclear reactor core balanced by cooling provided by steam generation and subsequent condensation (i.e. a steam cycle). Safety protocols require that one or more systems be designed to address the event of a failure of the reactor pressure boundary, which includes the vessel and attached piping up to nominally closed isolation valves, known in the art as a loss of coolant accident, i.e. LOCA. During a LOCA, liquid primary coolant escapes and flashes to steam outside the pressure vessel. A radiological containment (sometimes called primary containment or simply containment) surrounds the pressure vessel to contain any such steam release, and an automatic reactor shutdown is performed to extinguish the nuclear reaction, typically including scram of control rods and optionally injection of borated water or another soluble neutron poison into the primary coolant in the pressure vessel. An emergency core cooling system (EGGS) and/or other safety systems also respond by removing decay heat from the nuclear reactor and condensing and recapturing any primary coolant steam released into the radiological containment.

The radiological containment is usually a concrete, steel or steel-reinforced concrete structure. Safety protocols require that one or more systems are available to mitigate any pressure rise in the reactor radiological containment (e.g., due to escaping primary coolant flashing to steam). For example, in the United States, General Design Criteria (GDC) for nuclear reactors (see 10 CFR §50, Appendix A (2012)) require a system to remove heat from the reactor radiological containment and to maintain pressure and temperature at acceptable levels. See GDC 38. Related to long-term event recovery, eventual reentry to the reactor radiological containment also requires pressure equilibrium between the reactor radiological containment and its surroundings.

Disclosed herein are improvements that provide various benefits that will become apparent to the skilled artisan upon reading the following.

### BRIEF SUMMARY

In one aspect of the disclosure, an apparatus comprises: a nuclear reactor including a pressure vessel containing primary coolant water and a nuclear reactor core comprising fissile material; a reactor radiological containment structure surrounding the nuclear reactor; a pool of water (e.g., a spent fuel pool) located outside of the reactor radiological containment structure; and a steam pipe having an inlet end open to the reactor radiological containment structure and a discharge end submerged in the pool of water. A spent fuel pool radiological containment structure may contain the spent fuel pool, and a refueling tunnel suitably connects the reactor radiological containment structure and the spent fuel pool radiological containment structure. In some embodiments the discharge end of the steam pipe is submerged a depth of at least 15 feet in the spent fuel pool. The inlet end of the steam pipe may include an isolation valve.

An apparatus of some embodiments set forth of the immediately preceding paragraph may further comprise: a second nuclear reactor including a pressure vessel containing primary coolant water and a nuclear reactor core comprising fissile material; a second reactor radiological containment structure surrounding the second nuclear reactor; a second refueling tunnel connecting the second reactor radiological containment structure and the spent fuel pool radiological containment structure; and a second steam pipe having an inlet end open to the second reactor radiological containment structure and a discharge end submerged in the spent fuel pool.

In another aspect of the invention, a method comprises: operating a nuclear reactor including a pressure vessel containing primary coolant water and a nuclear reactor core comprising fissile material, the nuclear reactor being contained in a reactor radiological containment structure surrounding the nuclear reactor; and responding to a steam release into the reactor radiological containment structure by discharging the released steam into a spent fuel pool that contains spent nuclear fuel. The discharging may comprise opening an isolation valve on a steam pipe running from the reactor radiological containment structure into the spent fuel pool. The discharging may comprise sparging the steam into the spent fuel pool at a depth of at least 15 feet. The method may further comprise performing a reactor refueling operation including terminating the operating and transferring spent nuclear fuel from the nuclear reactor into the spent fuel pool via a refueling tunnel passing from the reactor radiological containment into a containing structure surrounding the spent fuel pool. The method may further comprise providing radiological containment of the spent fuel pool by such a containing structure surrounding the spent fuel pool.

In another aspect of the disclosure, an apparatus comprises: a first nuclear reactor including a pressure vessel containing primary coolant water and a nuclear reactor core comprising fissile material; a second nuclear reactor including a pressure vessel containing primary coolant water and a nuclear reactor core comprising fissile material; a first reactor radiological containment structure surrounding the first nuclear reactor but not the second nuclear reactor; a second reactor radiological containment structure surrounding the second nuclear reactor but not the first nuclear reactor; and a steam pipe connecting the first reactor radiological containment structure and the second reactor radiological containment structure, the steam pipe including an isolation valve. The apparatus may further comprise radiological contaminant filters disposed at inlets of the pipe or along the pipe.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows an illustrative nuclear reactor together with its associated containment structure and ultimate heat sink.

FIGS. 2 and 3 diagrammatically show side and overhead views, respectively, of two nuclear reactors and their respective radiological containment structures of the illustrative type shown in FIG. 1, in conjunction with a radiological containment pressure relief system including a common spent fuel pool.

FIG. 4 is a graph comparing estimated pressure and temperature in the containment with and without operation of the pressure relief system including the spent fuel pool shown in FIGS. 2 and 3.

FIG. 5 diagrammatically shows a side view of two nuclear reactors and their respective associated containment structures of the type shown in FIG. 1, in conjunction with a radiological containment pressure relief system including coupling between the two radiological containments.

### DETAILED DESCRIPTION OF THE PREFERRED EMBODIMENTS

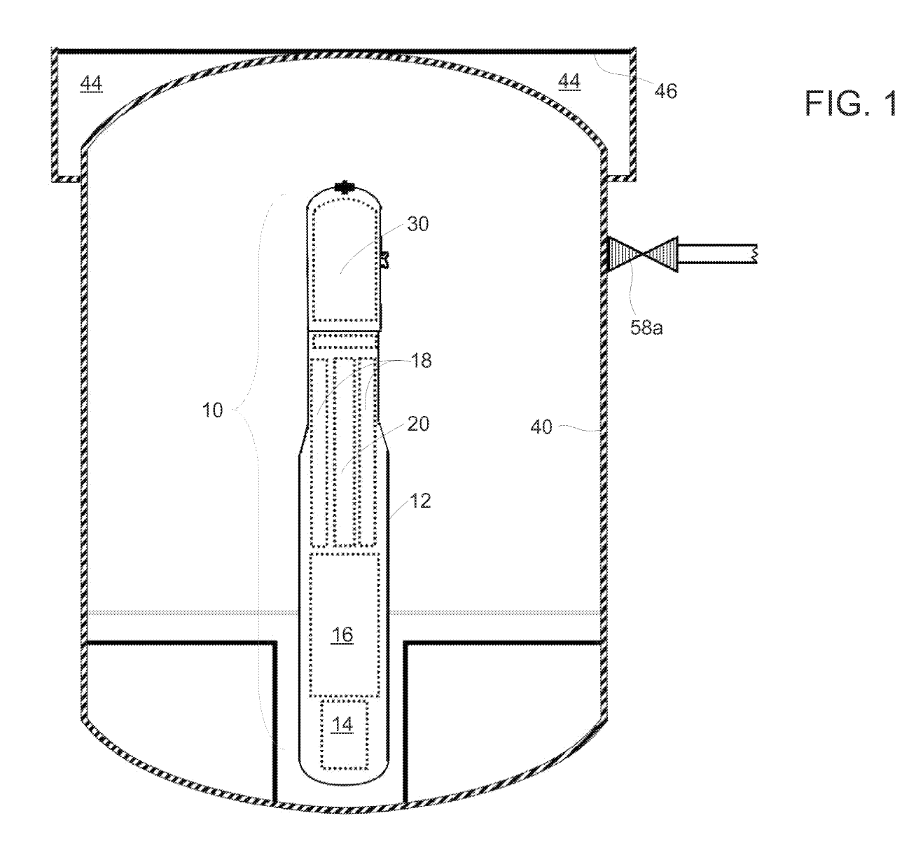

With reference to FIG. 1, an illustrative nuclear reactor of the pressurized water reactor (PWR) type 10 includes a pressure vessel 12, which in the illustrative embodiment is a generally cylindrical vertically mounted vessel. Selected components of the PWR that are internal to the pressure vessel 12 are shown diagrammatically in phantom (that is, by dashed lines). A nuclear reactor core 14 is disposed in a lower portion of the pressure vessel 12. The reactor core 14 includes a mass of fissile material, such as a material containing uranium oxide (UO₂) that is enriched in the fissile ²³⁵U isotope, in a suitable matrix material. In a typical configuration, the fissile material is arranged as “fuel rods” arranged in a core basket (details not shown). The pressure vessel 12 contains primary coolant water (typically light water, that is, H₂O, although heavy water, that is, D₂O, is also contemplated) in a subcooled state.

A control rod system 16 is mounted above the reactor core 14 and includes control rod drive mechanism (CRDM) units and control rod guide structures (details not shown) configured to precisely and controllably insert or withdraw control rods into or out of the reactor core 14. The illustrative control rod system 16 employs internal CRDM units that are disposed inside the pressure vessel 12. Some illustrative examples of suitable internal CRDM designs include: Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Intl Pub. WO2010/144563A1 published Dec. 16, 2010 which is incorporated herein by reference in its entirety. In general, the control rods contain neutron absorbing material, and reactivity is increased by withdrawing the control rods or decreased by inserting the control rods. So-called “gray” control rods are continuously adjustable to provide incremental adjustments of the reactivity. So-called “shutdown” control rods are designed to be inserted as quickly as feasible (e.g. fall under gravity) into the reactor core 12 to shut down the nuclear reaction in the event of an emergency. Various hybrid control rod designs are also known. For example, a gray rod may include a mechanism for releasing the control rod in an emergency so that it falls into the reactor core 12 thus implementing a shutdown rod functionality.

The illustrative PWR 10 is an integral PWR in that it includes an internal steam generator 18 disposed inside the pressure vessel 12. In the illustrative configuration, a cylindrical riser 20 is disposed coaxially inside the cylindrical pressure vessel 12. Primary coolant flows around and through the control rods system 16 and then flows upward, such that primary coolant water heated by the operating nuclear reactor core 14 rises upward through the cylindrical riser 20 toward the top of the pressure vessel, where it discharges, reverses flow direction and flows downward through an outer annulus defined between the cylindrical riser 20 and the cylindrical wall of the pressure vessel 12. This circulation may be natural circulation that is driven by reactor core heating and subsequent cooling of the primary coolant, or the circulation may be assisted or driven by primary coolant pumps (not shown). The illustrative steam generator 18 is an annular steam generator disposed in the outer annulus defined between the cylindrical riser 20 and the cylindrical wall of the pressure vessel 12. Secondary coolant enters and exits the steam generator 18 via suitable respective feedwater inlet and steam outlet ports (not shown) of the pressure vessel 12. Typically, the feedwater flows upward through the steam generator 18 where it is heated by the proximate downwardly flowing primary coolant to heat the feedwater into steam. Various steam generator configurations can be employed. Some illustrative steam generators are described in Thome et al., “Integral Helical Coil Pressurized Water Nuclear Reactor”, U.S. Pub. No. 2010/0316181 A1 published Dec. 16, 2010 which is incorporated herein by reference in its entirety; and Malloy et al., U.S. Pub. No. 2012/0076254 A1 published Mar. 29, 2012 which is incorporated herein by reference in its entirety. In other embodiments (not shown), the PWR is not an integral PWR; rather the steam generator is located externally and is connected with the reactor pressure vessel by suitable large-diameter piping carrying primary coolant to and from the steam generator.

The illustrative PWR is merely an example, and it is to be understood that the radiological containment pressure relief systems and methods disclosed herein are readily employed in conjunction with any type of nuclear reactor, e.g. an intregal PWR (illustrated), or a PWR with an external steam generator, or a BWR, or so forth.

Continuing with FIG. 1, the pressure vessel 12 defines a sealed volume that, when the PWR is operational, contains primary coolant water in a subcooled state. Toward this end, the PWR includes an internal pressurizer volume 30 disposed at the top of the pressure vessel 12. The internal pressurizer volume 30 contains a steam bubble of primary coolant whose pressure controls the pressure of the primary coolant water in the pressure vessel 12. Various resistive heaters, spargers, or so forth (not shown) may be provided to control the steam bubble pressure. At least one steam pressure control device is provided to heat or cool the steam bubble to control pressure. Alternatively, an external pressurizer (not shown) may be provided, and connected with the pressure vessel by suitable piping. By way of illustrative example, in some embodiments the primary coolant pressure in the sealed volume of the pressure vessel 12 is at a pressure of about 2000 psia and at a temperature of about 570-610° F. These are merely illustrative values, and a diverse range of other operating pressures and temperatures are also contemplated. In the case of a BWR, the pressure is lower, e.g. about 1000-1100 psi in some systems, to permit a portion of the primary coolant to boil.

With continuing reference to FIG. 1, the PWR 10 is disposed in a radiological containment structure 40, which may by way of illustrative example comprise concrete, steel, or steel-reinforced concrete. The radiological containment structure 40 is designed to contain any primary coolant (either steam or water) released from the PWR 10 in the event of a LOCA or design-basis intentional venting of the pressure vessel 12. In some embodiments, the containment structure 40 may be partially or wholly subterranean; for example, the illustrative containment 40 is mostly subterranean and includes an ultimate heat sink (UHS) pool 44 above the containment at about ground level 46.

The illustrative radiological containment 40 is merely an example, and it is to be understood that the radiological containment pressure relief systems and methods disclosed herein are readily employed in conjunction with any type of radiological containment, whether above-ground or partially or wholly subterranean, whether including or omitting a flood well, and regardless of the type and location of the ultimate heat sink. For example, instead of an UHS pool, the ultimate heat sink could instead be a cooling tower, a neighboring river, or so forth. In particular, the UHS does not need to be in contact with the containment as in the illustrative embodiment, but rather could be some distance away from containment.

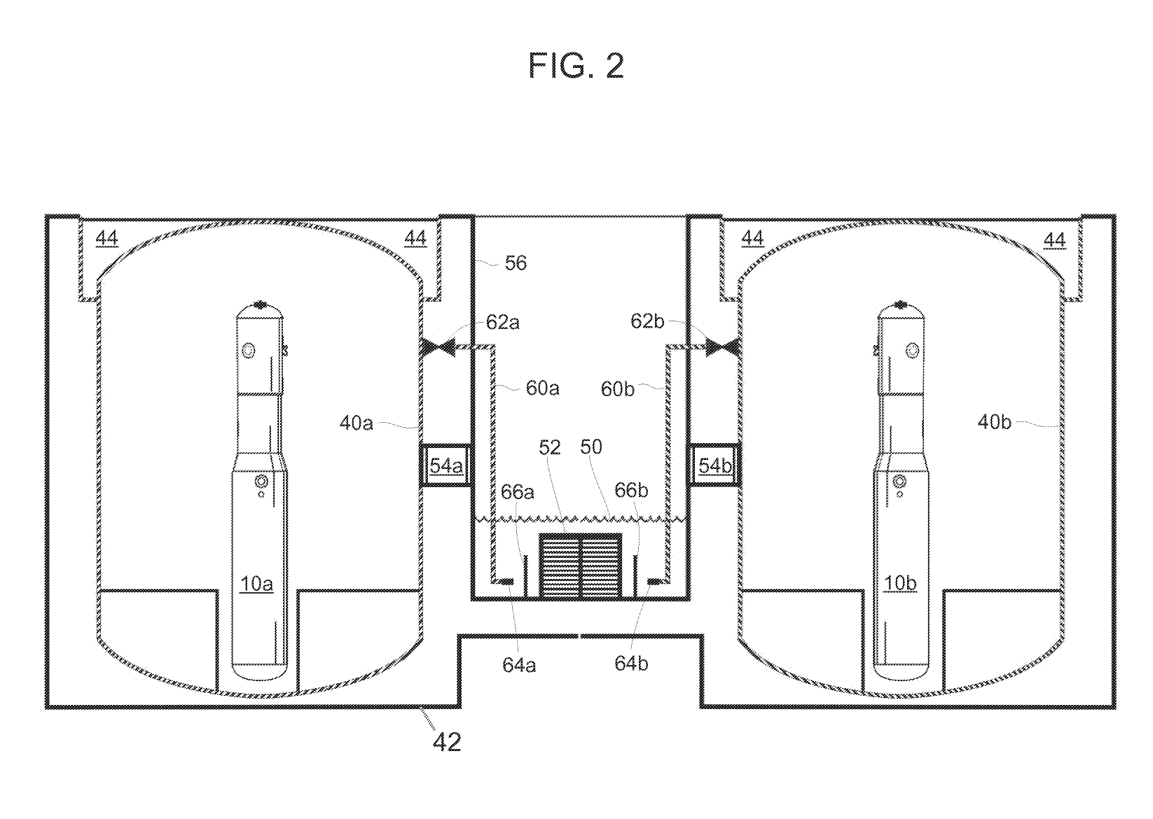

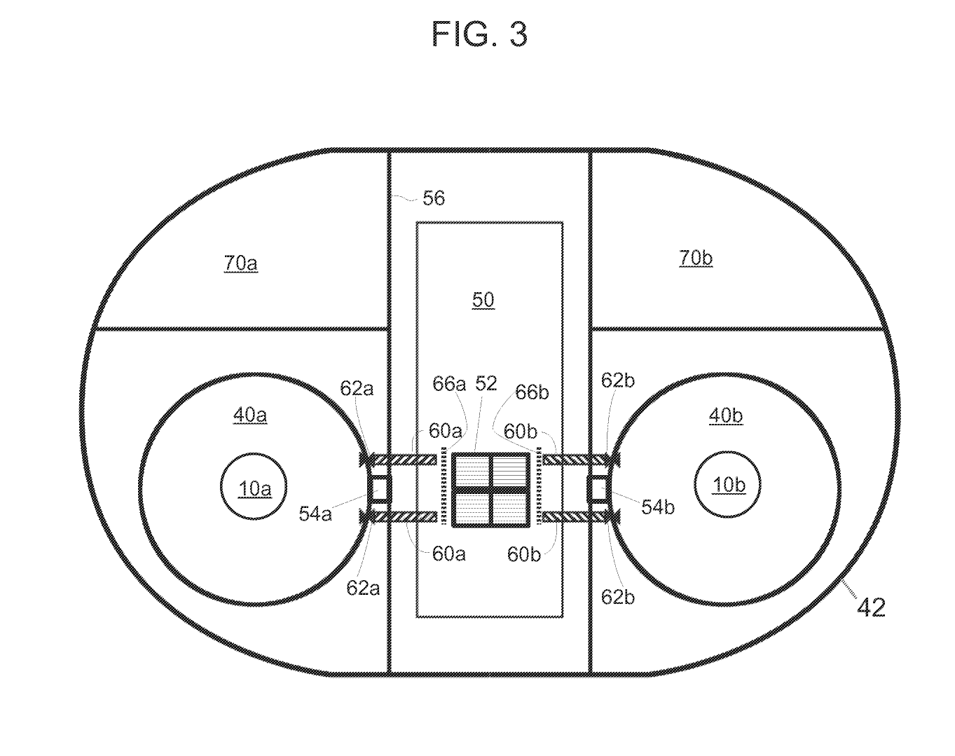

FIGS. 2 and 3 diagrammatically show side and overhead (i.e. plan) views, respectively, of a nuclear power plant design that includes two nuclear reactor units of the type shown in FIG. 1 (i.e., a “two-pack” design). In the two-pack nuclear power plant of FIGS. 2 and 3, two nuclear reactor units 10a, 10b are disposed in separate respective radiological containment structures 40a, 40b. Each nuclear reactor unit 10a, 10b is substantially the same as the nuclear reactor 10 already described with reference to FIG. 1, and similarly each containment structure 40a, 40b is substantially the same as the radiological containment 40 already described with reference to FIG. 1. (Note that in FIG. 3, the UHS pool 44 is omitted). The two reactors 10a, 10b in their respective radiological containments 40a, 40b are typically located inside an outer reactor service building (RSB) 42 or other secondary structure, which provides additional structural support and may also provide some secondary radiological containment capability. However, the RSB 42 or other secondary structure does not provide primary radiological containment as defined by applicable nuclear regulations (e.g. NRC regulations in the United States, or similar nuclear regulations in most other countries).

The two reactor units share a common spent fuel pool 50, which (at least after the first refueling operation) contains spent fuel 52, possibly stored in racks. The spent fuel pool 50 contains circulating water that provides cooling and radiological shielding for the spent fuel 52. Although the nuclear chain reaction is fully extinguished in the spent fuel 52, it remains radioactive due to residual intermediate reaction products with decay half-life values on the order of a few minutes to a few years or longer. Thus, the spent fuel 52 is typically kept in the spent fuel pool 50 for a period of time, typically a few months to a few years, until its residual radioactivity has diminished sufficiently to allow casking and optional transfer off-site.

In general, the spent fuel pool 50 is located close to the nuclear reactor units 10a, 10b. During refueling of reactor unit 10a, a refueling tunnel 54a passing from the containment 40a to the spent fuel pool 50 is opened, and spent fuel removed from reactor unit 10a using a crane or other lifting apparatus (not shown) is transferred via the tunnel 54a to the spent fuel pool 50. Similarly, during refueling of reactor unit 10b, a refueling tunnel 54b passing from the containment 40b to the spent fuel pool 50 is opened, and spent fuel from the reactor unit 10b is transferred via the tunnel 54b to the spent fuel pool 50. Because the spent fuel has substantial residual radioactivity, it must be kept submerged in water throughout the removal process. Accordingly, during refueling of reactor unit 10a both the containment 40a and a structure 56 containing the spent fuel pool 50 are flooded with water at least up to a level sufficient to submerge the tunnel 54a. Similarly, during refueling of reactor unit 10b both the containment 40b and the structure 56 are flooded with water at least up to a level sufficient to submerge the tunnel 54b. In the illustrative two-pack nuclear plant design, the spent fuel pool 50 and its containing structure 56 are located in the same reactor service building (RSB) 42 that also houses the reactors 10a, 10b and their respective containments 40a, 40b (thus also making the containing structure 56 mostly or completely subterranean), although other structural arrangements are also contemplated.

The spent fuel pool 50 is located close to the nuclear reactor units 10a, 10b to keep the tunnels 54a, 54b short and to limit the distance over which the radioactive spent fuel must be transferred. In the illustrative two-pack design shown in FIG. 2, the common spent fuel pool 50 is placed between the two reactor units 10a, 10b so as to locate the spent fuel pool 50 close to both reactor units. If two separate spent fuel pools service the two reactor units, then each spent fuel pool need only be close to its serviced reactor unit. In a single reactor unit power plant, the (typically single) spent fuel pool should be close to the reactor unit.

The structure 56 containing the spent fuel pool 50 is a separate volume from the two reactor containments 40a, 40b. The volume of water making up the spent fuel pool 50 is large in order to ensure the spent fuel remains submerged even in the event of a prolonged interruption of the outside water supply (e.g. seven days or longer in some design-basis events). Additionally, applicable nuclear regulations typically require that the structure 56 be constructed as a radiological containment (although not necessarily to the strict standards of the reactor containment structures 40a, 40b).

It is recognized herein that this large body of water, the spent fuel pool 50, can be leveraged as a condensation pool to quench primary coolant steam released into containment during a LOCA or design-basis primary coolant venting operation. The containing structure 56 is typically already a radiological containment, which can readily be upgraded (if required by applicable nuclear regulations) in order to meet the more strict radiological containment standards applied to the reactor containment. The large volume of the spent fuel pool 50 provides substantial capacity for quenching released primary coolant steam without significantly depleting the volume of the spent fuel pool. Moreover, since the spent fuel pool is located close to the serviced nuclear reactor(s), the length of piping required to flow steam from reactor containment into the spent fuel pool is relatively short.

Accordingly, with continuing reference to FIGS. 2 and 3, each containment 40a, 40b is connected to the spent fuel pool 50 by valved steam piping 60a, 60b. In the illustrative embodiment, each containment structure 40a, 40b has two such connecting steam pipes for redundancy. Each steam pipe has an isolation valve 62a, 62b. The illustrative isolation valves 62a, 62b are located at the penetration where the pipe 60a, 60b interfaces into the reactor containment 40a, 40b (that is, at the pipe “inlet”) so that a break anywhere along the pipe can be isolated from containment; however, other locations for the isolation valves are contemplated. The pipe inlets are preferably located above the water line of the spent fuel pool 50 so that water backflow into the pipe is limited to the outlet end portion that is submerged in the spent fuel pool.

In one embodiment, each steam pipe 60a, 60b is a 100% duct, designed to ASME vessel code. The discharge end (that is, the end that is submerged in the spent fuel tank 50 and from which primary coolant steam discharges during depressurization of the reactor containment) of each steam pipe 60a, 60b optionally includes a baffle or sparger 64a, 64b to reduce the velocity and dissipate the energy of the steam discharging into the pool. Additionally or alternatively, flow dissipation devices may be disposed in the spent fuel pool 50, such as an illustrative walls, grates, or screens 66a, 66b between the fuel racks 52 and the discharge ends of the pipes 60a, 60b.

Although the steam piping is shown with two 90° turns and horizontal discharge (best seen in FIG. 2), it is also contemplated that the steam piping could remain vertical as it entered the spent fuel pool and discharge vertically, directly downward. It is also contemplated that, after entering the pool, the steam pipe could turn 90° toward the exterior wall of the pool. In these cases the bottom or exterior wall of the spent fuel pool can serve as a flow velocity dissipation device. It is also contemplated for one or both illustrated 90° turns to be smoothed, which may reduce flow resistance.

Depending upon the depth of the spent fuel pool 50 and the depth at which the pipes 60a, 60b discharge, a sort of hydraulic valve can be formed. Considering reactor 10a as an example, even with the valve 62a open, overpressure in the reactor containment 40a, 40b cannot discharge into the spent fuel pool 50 unless the overpressure is sufficient to overcome the weight of the column of water in the portion of the pipe 60a in the water. For example, if the pipe 60a extends downward to a depth of 4 feet below the surface of the spent fuel pool 50, the overpressure of steam in the reactor containment 40a (respective to the pressure over the pool) would have to exceed about 20 psi in order to expel the water in the pipe and flow steam from the containment 40a into the spent fuel pool 50.

Because reactor containment 40a and/or reactor containment 40b blows down to the spent fuel pool 50, the containment 56 of the spent fuel pool 50 may be required under applicable nuclear regulations to be constructed to ASME code for concrete containments and/or include a filtered vent (not shown) to relieve elevated pressure, or to otherwise comply with applicable radiological containment requirements. In some embodiments, it is contemplated to extend the UHS pool 44 over the spent fuel pool containment 56. However, it should be noted that since the pipes 60a, 60b discharge at some depth (e.g., 15 feet or more) below the surface of the spent fuel pool 50, the steam is expected to condense to water inside the pool and should not appreciably raise the pressure inside the containment 56 of the spent fuel pool 50. Similarly, introduction of airborne radioactive contaminants to the air inside the containment 56 is expected to be limited since the contaminants should dissolve in or otherwise remain in the water. (In other words, the water serves as a scrubber for the discharging primary coolant steam).

With particular reference to FIG. 3, refueling maintenance and storage area 70a, 70b are provided, which may store, for example, cranes and other equipment for use during reactor refueling.

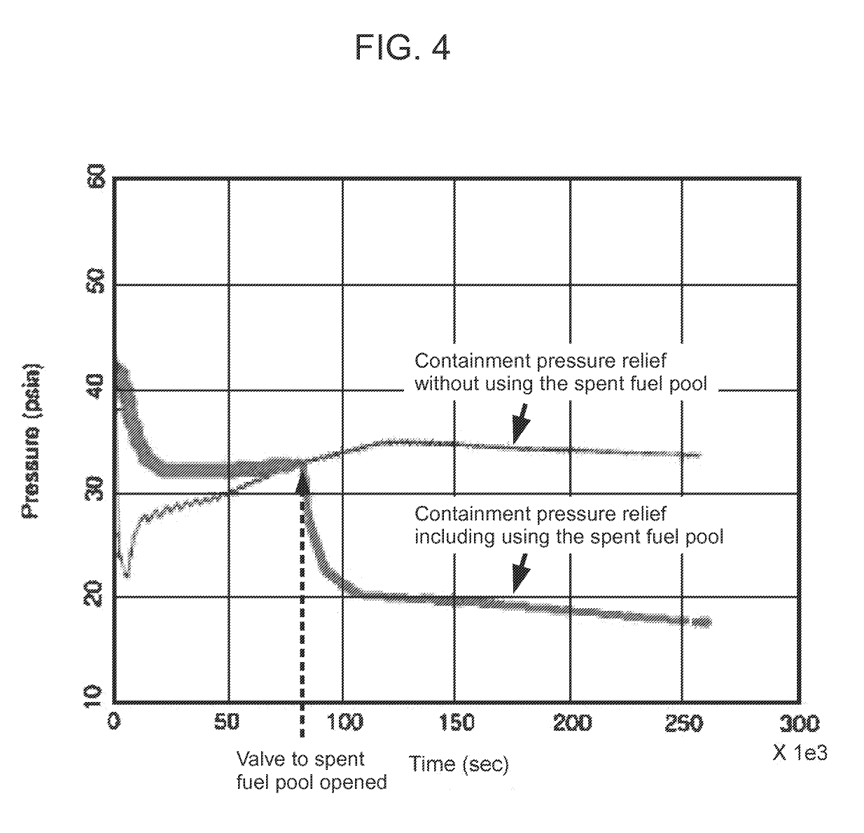

FIG. 4 shows results of a preliminary containment safety analysis. The analysis was for an integral PWR similar to that depicted in FIGS. 1-3, conforming with the mPower™ Small Modular Reactor design under development by Babcock & Wilcox. See, e.g. http://www.babcock.com/products/modular_nuclear/ (last accessed Oct. 1, 2013). FIG. 4 plots reactor radiological containment pressure as a function of time with and without blow down into the spent fuel pool for containment pressure relief. Without blowdown (i.e. using only the ECCS), the simulated LOCA results in elevated containment pressure for the duration of a 72-hour performance demonstration (one day is 86400 sec). Blowdown to the spent fuel pool (in addition to also using ECCS) upon opening the valve at about the 24 hour (86,400 sec) point is seen to have an immediate impact in sharply decreasing reactor containment pressure. It will be appreciated that the precise impact of blow down into the spent fuel pool will depend on factors such as the volume of the reactor containment structure and the diameter of the piping running from reactor containment into the spent fuel pool. The simulation of FIG. 4 is for a pipe diameter of about 12-16 inches (30-40 cm).

Although response to a LOCA or other venting of primary coolant in reactor radiological containment has been described, it will be appreciated that the disclosed approach of blow down into the spent fuel pool is also useful in other event scenarios in which an overpressure arises inside reactor containment. For example, in the illustrative integral PWR, rupture of the steam line inside containment carrying secondary coolant steam (that is, working steam) out of the reactor can release secondary coolant steam into the containment, and this could be blown down into the spent fuel pool using the same hardware as that described herein for blow down in response to a LOCA.

Blow down into the spent fuel pool, as disclosed herein, synergistically utilizes the spent fuel pool which is required to be close to the reactor for other reasons and is required to contain a large volume of water, for the purpose of accommodating overpressure in reactor containment. Advantageously, the spent fuel pool already usually has some sort of radiological containment, and at most this containment may need to be enhanced to meet applicable regulations when the spent fuel pool is used for blow down of steam from reactor containment. While using the spent fuel pool for this purpose has synergistic advantages as disclosed herein, it is alternatively contemplated to blow down to a dedicated body of water, other than the spent fuel pool, that is located close to the reactor and has suitable radiological containment.

In describing the illustrative containment discharge embodiments, the following terminology is used herein. Terms such as “normally open” or “normally closed” refer to the normal condition or state of the valve or other element during normal operation of the PWR 10 for its intended purpose (for example, the intended purpose of generating electrical power in the case of a nuclear power plant). A term such as “abnormal operation signal” refers to a signal generated by a sensor or other device indicating that some metric or aspect of the PWR operation has deviated outside of the normal PWR operational space. By way of illustrative example, an abnormal operation signal may comprise a low reactor water level signal, or an abnormal operation signal may comprise a high containment pressure signal. A low reactor water level signal may indicate a LOCA, as may a high containment pressure signal. Typically, an abnormal operation signal (or a combination of such signals) will automatically trigger an audible, visual, or other alarm to notify reactor operation personnel of the deviation, and/or will trigger an automated response, such as an opening of one of isolation valves 62a, 62b. In some cases and in some embodiments, reactor operation personnel may be able to override or cancel an automated response. In some cases and in some embodiments, the response to an abnormal operation signal or a combination of such signals may be initiated manually by reactor operation personnel.

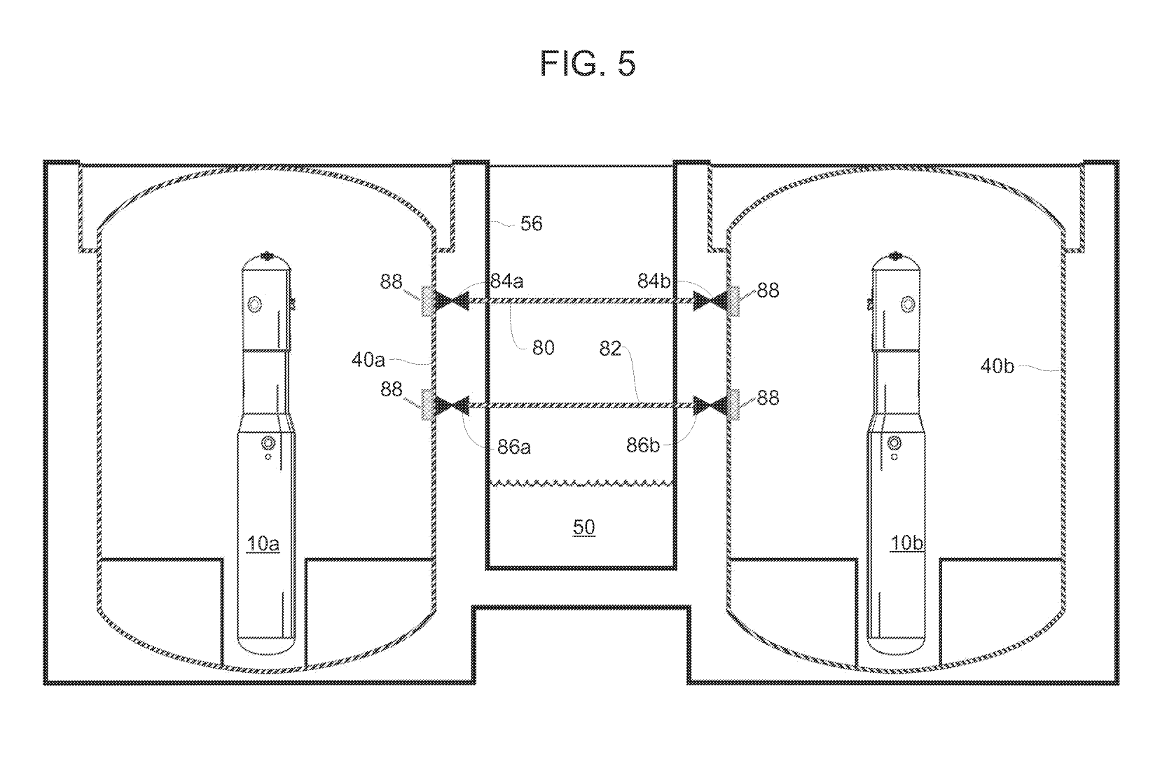

FIG. 5 shows an alternative embodiment in which two reactor containment structures 40a and 40b are cross-connected. That is, the reactor containments 40a, 40b are directly coupled by valved steam piping 80, 82. A LOCA in one reactor (say reactor unit 10a) will pressurize its containment (radiological containment 40a in this example). By use of the coupling piping 80, 82, the overpressure in containment 40a transfers to containment 40b. In effect, the volume for accommodating the escaped primary coolant steam is doubled (neglecting flow resistance in the pipes 80, 82). Shown are two steam pipes connecting the reactor containment structures for redundancy, though as few as one pipe, or more than two pipes, may be provided. Each steam pipe 80, 82 has two isolation valves 84a, 84b, 86a, 86b, one proximate to each containment 40a, 40b. Alternatively, as few as a single isolation valve per pipe may be installed between the containments. Each pipe 80, 82 is suitably designed to ASME vessel code. It should be noted that while the illustrative pipes 80, 82 pass through the containment 56 of the spent fuel pool 50, other routes for the pipes may be used (though the illustrated route is advantageously the shortest route for this two-pack nuclear power plant design). Radiological contaminant filters 88 (e.g. HEPA filters, charcoal filters, or so forth) are optionally disposed at inlets of the pipes 80, 82 (or somewhere along the pipes) to minimize the radiological “cross-talk” between the two containments 40a, 40b. Placing the filters 88 at the inlets, as shown in FIG. 5, advantageously enables cleanup by replacing only the filters at the inlets of the contaminated reactor radiological containment structure.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a nuclear reactor including a pressure vessel containing primary coolant water and a nuclear reactor core comprising fissile material;
a reactor radiological containment structure surrounding the nuclear reactor;
a pool of water located outside of the reactor radiological containment structure; and
a steam pipe having an inlet end open to the reactor radiological containment structure and a discharge end submerged in the pool of water.

2. The apparatus of claim 1 wherein the pool of water is a spent fuel pool.

3. The apparatus of claim 2 further comprising:
a spent fuel pool radiological containment structure containing the spent fuel pool.

4. The apparatus of claim 3 further comprising:
a refueling tunnel connecting the reactor radiological containment structure and the spent fuel pool radiological containment structure.

5. The apparatus of claim 4 further comprising:
a second nuclear reactor including a pressure vessel containing primary coolant water and a nuclear reactor core comprising fissile material;
a second reactor radiological containment structure surrounding the second nuclear reactor;
a second refueling tunnel connecting the second reactor radiological containment structure and the spent fuel pool radiological containment structure; and
a second steam pipe having an inlet end open to the second reactor radiological containment structure and a discharge end submerged in the spent fuel pool.

6. The apparatus of claim 5 wherein the spent fuel pool is disposed between the nuclear reactor and the second nuclear reactor.

7. The apparatus of claim 2 wherein a wall, screen, or grate in the spent fuel pool separates the discharging end of the steam pipe from spent nuclear fuel contained in the spent fuel pool.

8. The apparatus of claim 2 wherein the discharge end of the steam pipe includes a baffle or sparger.

9. The apparatus of claim 2 wherein the discharge end of the steam pipe is submerged a depth of at least 15 feet in the spent fuel pool.

10. The apparatus of claim 2 wherein the inlet end of the steam pipe includes an isolation valve.

11. The apparatus of claim 2 wherein the steam pipe has a diameter of at least 12 inches.

12. The apparatus of claim 2 wherein the steam pipe has a diameter of between 12 inches and 16 inches inclusive.

13. The apparatus of claim 1 wherein the discharge end of the steam pipe is submerged a depth of at least 15 feet in the pool of water and includes a baffle or sparger.

14. The apparatus of claim 1 wherein the inlet end of the steam pipe includes an isolation valve.

15. A method comprising:
operating a nuclear reactor including a pressure vessel containing primary coolant water and a nuclear reactor core comprising fissile material, the nuclear reactor being contained in a reactor radiological containment structure surrounding the nuclear reactor; and
responding to a steam release into the reactor radiological containment structure by discharging the released steam into a spent fuel pool.

16. The method of claim 15 wherein the discharging comprises opening an isolation valve on a steam pipe running from the reactor radiological containment structure into the spent fuel pool.

17. The method of claim 16 wherein the discharging further comprises sparging the steam into the spent fuel pool at a depth of at least 15 feet.

18. The method of claim 15 wherein the discharging further comprises sparging the steam into the spent fuel pool at a depth of at least 15 feet.

19. The method of claim 15 further comprising:
performing a reactor refueling operation including terminating the operating and transferring spent nuclear fuel from the nuclear reactor into the spent fuel pool via a refueling tunnel passing from the reactor radiological containment into a containing structure surrounding the spent fuel pool.

20. The method of claim 19 further comprising:
providing radiological containment of the spent fuel pool by the containing structure surrounding the spent fuel pool.

21. An apparatus comprising:
a first nuclear reactor including a pressure vessel containing primary coolant water and a nuclear reactor core comprising fissile material;
a second nuclear reactor including a pressure vessel containing primary coolant water and a nuclear reactor core comprising fissile material;
a first reactor radiological containment structure surrounding the first nuclear reactor but not the second nuclear reactor;
a second reactor radiological containment structure surrounding the second nuclear reactor but not the first nuclear reactor; and
a steam pipe connecting the first reactor radiological containment structure and the second reactor radiological containment structure, the steam pipe including an isolation valve.

22. The apparatus of claim 21, further comprising:
radiological contaminant filters disposed at inlets of the pipe or along the pipe.

23. The apparatus of claim 22, wherein the radiological contaminant filters are disposed at inlets of the pipe.

24. The apparatus of claim 22, wherein the radiological contaminant filters include HEPA filters.

25. The apparatus of claim 22, wherein the radiological contaminant filters include charcoal filters.
